(19) United States
(12) Patent Application Publication
(10) Pub. No.: US 2002/0116318 A1
(43) Pub. Date: Aug. 22, 2002

(54) Electronic market and related methods suitable for transportation and shipping services

(75) Inventors: Anthony Robert Thomas, Middletown, MD (US); Robert James Simonoff, Middletown, MD (US); William Frank Welch JR., Frederick, MD (US); Thomas Drolet, Germantown, MD (US); Huai-Tsen Y. Chu, Havertown, PA (US); Srinivas Rajagopal, Malvern, PA (US); Suresh Acharya, Dowingtown, PA (US); Gregg Lanyard, Falls Church, VA (US); Lawrence Elliot Katzman, Bethesda, MD (US); Mark Shaffer, Centreville, VA (US); Vinodh Soundarajan, Phoenixville, PA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 09/942,774

(22) Filed: Aug. 31, 2001

Related U.S. Application Data
(60) Provisional application No. 60/229,026, filed on Aug. 31, 2000.

(51) Int. Cl. G06F 17/60

(52) U.S. Cl. 705/37

(57) ABSTRACT

The disclosed invention provides an electronic market and related methods particularly useful for negotiating the exchange of transportation services between shippers or carriers and shipping customers. Embodiments include an electronic catalog-type listing of carrier services and related rates such that buyers can purchase services at periodically listed prices, and an electronic auction exchange whereby buyers can bid on the available capacity of carriers or whereby carriers can bid on shipping orders requested by customers. In preferred embodiments, carriers and shipping customers can take into account pre-existing business relationships by designating other carriers and/or customers as preferred business partners or customers. Participation in auctions or qualification for discounted catalog rates can be limited only to those preferred partners or customers. In a second embodiment, the electronic market additionally enables the automatic tendering of shipment requests to carriers and automates the monitoring of acceptances from those carriers. A preferred version of the second embodiment employs electronic tracking and tracing of shipments, provides subscription based notifications, and enables integration with accounts payable and receivable systems.

### CROSS REFERENCE TO RELATED APPLICATION

This application claims priority from U.S. Provisional Patent Application Ser. No. 60/229,026, filed Aug. 31, 2000, the disclosure of which is hereby incorporated by reference in its entirety.

### FIELD OF THE INVENTION

The present invention relates to a system and method for providing an electronic market for transportation and shipping services. More particularly, the present invention further relates to electronic markets and related methods for facilitating the processes of negotiating between buyers and sellers for the sale of transportation and shipping services.

### BACKGROUND OF THE INVENTION

While the ability of shippers to get parcels from the loading dock to the final destination in shorter time spans and at less cost has increased in recent years, businesses that rely heavily upon independent shipping services and common carriers still desire more efficient and lower cost transportation solutions. The growth of shipping demand has fueled many advances in technology that shippers and carriers have been developing. As a result of our global and electronic economy, however, it remains that the volume of parcels being shipped has continued to spiral upward at a rate whereby the introduction of more efficient shipping markets could save many industries millions of dollars yearly.

Various approaches have been introduced in an attempt to more efficiently handle the increased volume of parcels and the proliferation of carrier services that are available. A majority of these approaches have introduced systems and methods that are targeted for internal use by single carriers to help improve that single carrier's costs and services. For example, current known technology allows clients of shipping carriers to track the status of goods in transport in real time. Parcel and express carriers, such as Federal Express™, the United Parcel Service™ (UPS™) or DHL™, typically assign a unique parcel identification, known as an Air Bill number, to each delivery. This unique designation for each parcel or order is assigned by providing two-part forms to the shipping customer, each including a unique, pre-printed bar code corresponding to the Air Bill number. One part of a form is attached to the parcel, while the shipping customer retains the other part of the form. The parcel identification (“ID”) barcode on the parcel is then optically scanned at each stage of delivery to track the progress for the parcel electronically. The barcode scanner communicates with a host computer to transmit the parcel ID to a host computer. The parcel ID and the location information of the barcode scanner are then transmitted by the host computer to one or more web servers, each including a database for storing a record of the parcel ID's scanned at each location. Shipping customers can then, by running a web browser, link through the Internet or a direct dial-up connection to one of the service provider web servers, and thus the parcel status database table, by specifying a URL (a “universal resource locator” which is commonly known as a web page's address). The URL usually points to an HTML file that is transmitted to the transportation planning managers who are then prompted to enter the unique parcel ID. The parcel ID is transmitted to the service provider web server and used as search criteria by the service provider, which returns the current location of the parcel for display on the transportation planning managers' web browser.

When using traditional paper Air Bills, however, shipping customers must manually record and retain the tracking numbers for later use in looking up the status of a particular package or shipment. Additionally, prior art systems suffer from the fact that the customer must repeatedly re-access the URL to receive updates as to the status of a freight movement.

Additionally, it has become increasingly more popular for independent shipping fleets and common carriers in the freight industry to supply Internet web sites that include published rate information for specific services (shipping types, lanes, etc.) offered by that carrier. The shipping customer (i.e., the entity desiring to ship given cargo by one or more offered services) may then navigate to the carrier's web site at his or her convenience using a conventional web browser and obtain useful shipping and rate information.

While this approach is advantageous in that it provides customers with readily accessible rate and service information around the clock, there is the inherent drawback that shipping clients typically cannot obtain competitive rate information without having to visit multiple carrier web sites (or by calling those carriers who do not publish service and rate information) and manually compare the obtained rate information. Moreover, many carrier web sites do not provide current rate information to shipping customers without the customer first identifying itself (perhaps in a secure manner) to the carrier. Further, even if customers do spend the time searching across multiple sites to obtain competitive rate information, they are still limited to accepting the posted shipping lanes and/or rates.

As such, several attempts have been made in the prior art to provide automated and electronic markets that facilitate transportation transactions between many shippers and common carriers and many shipping customers. One such attempt, as disclosed in U.S. Pat. No. 5,835,716 issued to Hunt et al., employs a closed environment electronic market to broker excess shipping capacity from shippers/carriers. Hunt's system allows carriers to provide listings of available shipping capacity which are then matched (using parameters such as lanes, capacity and time frames) with appropriate shipping requests entered by customers.

Additionally, U.S. Pat. No. 6,064,981 to Barni et al. discloses an Internet based system that allows multiple carriers and multiple shipping customers to exchange shipping information electronically. The system disclosed by Barni allows carriers to post rates via an Internet web site and provides a mechanism whereby customers can either place secure orders based upon on those posted rates or can place secure anonymous bids in a online auction environment.

Current many-to-many electronic market solutions, like those proposed by Hunt and Barni, provide mechanisms for establishing a centralized market by which many shippers/carriers can compete for and transact business with many shipping customers in an electronically facilitated manner. While such electronic markets have various benefits and advantages, they are still not ideal. Unfortunately, currently available centralized electronic market solutions have not allowed carriers and shipping customers to adequately exploit established business relationships in a manner similar to what occurs in traditional real-life market situations.

It would be highly desirable to provide an improved electronic market wherein shipping customers can obtain cargo rates from shippers and/or carriers as well as negotiate shipping routes and pricing with those shippers/carriers in a manner that allows relationships as business partners to come into play. Additionally, it would be desirable that such a market may further allow organizations within the shipping industry to interact more directly with each other and customers through the Internet, an Intranet, or through another form of electronic communication (such as standards-based electronic data interchange, or “EDI”). In this way, organizations may use the electronic market to facilitate the automation of their individual transportation operations and may collaborate with carriers electronically and in real-time to improve customer service and to better optimize total transportation needs in the marketplace.

### SUMMARY OF THE INVENTION

In light of the drawbacks inherent in the prior art, it is an object of the present invention to provide an improved electronic market wherein shipping customers can obtain cargo rates from shippers and/or carriers as well as negotiate shipping routes and pricing with those shippers/carriers in a manner that allows relationships as business partners and associates to be adequately exploited in a manner similar to what occurs in traditional real-life market situations.

As such, it is an object of the present invention to provide an electronic market and related methods that enables carriers and shipping customers to conduct catalog-rate, discount-rate and negotiated-rate shipping transactions.

Concurrently, it is an object of the present invention to provide such an electronic market and method that operates across distributed computer networks like the Internet whereby users of the network can be located at various remote locations.

Further, it is an object of preferred embodiments of the present invention to provide electronic markets and related method whereby users can not only research and inquire about shipping services but also tender, accept, and execute agreed upon shipping services.

Additionally, it is an object of preferred embodiments of the present invention to provide an electronic market and related method that employs a multi-tier security regime for allowing individual user access and privileges to be homogenized within a collaborative, many buyer to many seller environment.

In response to the above-described and other needs and objects, the present invention provides an electronic market and related methods particularly useful for negotiating the exchange of transportation services between shippers or carriers and shipping customers. Embodiments of the present invention include an electronic catalog-type listing of carrier services (lanes, delivery times, etc.) and related rates such that buyers can purchase services at periodically listed prices, and an electronic auction exchange whereby buyers can bid on the available capacity of carriers or whereby carriers can bid on shipping orders requested by customers.

In preferred embodiments of the present invention, carriers and shipping customers alike are permitted to take into account preexisting business relationships by designating other carriers and/or customers as preferred business partners. Thus, according to such embodiments, carrier or shipper auctions can be classified as either public or private. In a public capacity auction exchange, any shipper or customer who is a participant of the electronic market and wishes to purchase some of the capacity at auction from a seller can enter bids on the available capacity. Similarly, in a public shipment auction exchange, any carrier who is a participant of the electronic market and wishes to perform the shipment desired by a customer can enter bids on the shipping order.

In the private auction exchange in such preferred embodiments, however, only users designated as preferred business partners may bid on the auctioned capacity of the particular shipper (or shipping order of a particular customer). Users designated as preferred business partners can consist of, for example, preferred partners designated by the selling party for all transactions (catalog and auctions), only for catalog transactions, or only for one or more particular auctions. In this manner, a selling carrier can cater its services to particular users (e.g., repeat customers) and target market segments in an attempt to garner better prices.

In additional preferred embodiments, capacity auctions can be designated private-public whereby capacity can be preferentially offered to users designated as preferred business partners in a private auction (bids being taken from only those preferred business partners) before potentially being made available in a public auction. For example, the users designated as preferred partners for a particular private auction could consist of other carriers (typically sellers). In this manner, carriers can designate each other as preferred members of a private auction (such as to implement a business agreement) to help one another remedy over-bookings or other circumstances that would cause a failure to provide transportation services as-promised to customers under contract. With such a private-public auction the seller can set a minimum reserve price such that if the reserve price is not exceeded by the bids of the designated users in the private auction, the auction could automatically be opened up as a public auction. Optionally, the switch from private to public auctioning can be triggered by other means including an inactivity timer and a manual signal from the user that initiated the auction.

When preferred embodiments of the present invention allow the designation of certain users as preferred business customers, alternative preferred embodiments allow auctioning entities to set multiple levels of preferred partners. In this manner, a primary set of preferred partners could be given initial access to auctioned capacity or shipping orders. In the event that the primary set does not provide a winning bid, the auction could be opened up to a secondary set of preferred partners and so on. Of course, according to this alternative preferred embodiment, any number of levels of preferred partners can be employed in this manner. Eventually, in the event that a winning bid is not received from any of the sessions comprising the multiple level private auction, the capacity or contract being auctioned privately could optionally be made available to all users via a public auction.

Additionally, in other preferred embodiments of the present invention, shippers can chose to provide special preferred customer catalog listings that, for example, provide discounted rates to the designated preferred catalog customers or, more preferably, multiple levels of preferred catalog customers. Thus, in this manner, loyal repeat customers could be quoted lower catalog rates on one or more shipping services offered as compared to the catalog rates quoted to less frequent repeat customers (who in turn could optionally be quoted a lower rate than the average customer).

Auctions in embodiments of the present invention can be performed under any auction bidding scheme known in the art. For example, a given auction can be open such that all users eligible to bid can view pending bids, or alternatively the bidding can be kept secret. Additionally, as described above, descending price buyer's auctions could be supported to allow sellers (i.e., shippers) to “bid” on purchase orders submitted by buyers. Finally, various auctions rules can be set. For example, a rule could state that contracts are awarded to the highest bidder at a price lower than the highest bid (such as the second highest bid) so as to prevent buyer's remorse. Other rules could allow bidders to set maximum bids with automatic increments if prior bids are beaten, or allow bids to have a time expiration feature.

According to a second embodiment of the present invention, the electronic market for shipping and transportation services according to the present invention additionally enables the automatic tendering of shipment requests (after the closing of auctions or after receipt of catalog orders) to carriers and automates the monitoring of acceptances, also preferably transmitted electronically, from those carriers.

Furthermore, preferred second embodiments of the present invention incorporate electronic tracking and tracing functionality that provides subscription based notifications. With the tracking and tracing functionality, users of the electronic market can log on to the system and obtain a detailed real-time shipping manifest including the present status or location of any shipment previously scheduled through the electronic market (as well as previous locations and statuses, etc.). Any user can additionally subscribe in such preferred embodiments of the electronic market and related method to receive notifications, preferably in the form of automatic emails, when a given shipment reaches a particular location or obtains a particular status. In this manner, while a company who is a participant in the electronic marketplace according to the present invention may have many different employees who are registered users, a user can receive an automatic email notifications when shipments reach their destination while a second and third registered users may subscribe to be notified if the shipment is delayed.

Additionally, certain preferred embodiments of the present invention comprise advanced tracking and tracing features that are linked to the billing accounts payable/receivable process. In this manner, a bill generation electronic data interchange (“EDI”) event could be automatically triggered to the proper user's account when a shipment reaches its destination for payment on delivery transactions.

Most preferred embodiments of the electronic market according to present invention utilize various computing devices communicating over a distributed network. In such preferred embodiments, the distributed network is the Internet and users may interact with the system using web browsers, various forms of EDI or like technologies. For example, the system may include a web server and appropriate software to support user access to the electronic market via standard web browsers.

Preferably, a three-tier security regime is employed in preferred electronic market networks according to embodiments of the present invention to help manage roles and responsibilities. This three-tier preferred security regime distinguishes between companies, groups, and users. Groups are subset of companies, and users are subsets of groups. Each group and user may only belong to one company, but any user can be associated with more than one group. In this manner, rights and permissions can be assigned on a company, group, and user basis to assist in the security maintenance process. In alternative embodiments, additional tiers to the security regime can be provided such as a fourth tier above the company level so as to allow companies to form associations (i.e., partnerships).

Additional features and advantages of the invention are set forth in the description that follows, and in part are apparent from the description, or may be learned by practice of the invention. The objectives and other advantages of the invention are realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings with like reference numbers representing corresponding parts throughout:

FIG. 1a is a schematic diagram depicting the inter-relation of the basic elements of an electronic market according to embodiments of the present invention;

FIG. 1b is a schematic diagram depicting an electronic exchange network according to one preferred embodiment of the present invention;

FIG. 2 is a flow diagram depicting the method utilized to conduct public auctions according to embodiments of the present invention;

FIG. 3 is a flow diagram depicting the method utilized to conduct private, multiple level private, and private-public auctions according to preferred embodiments of the present invention;

FIGS. 4a and 4b are flow diagrams depicting the methods utilized to automatically execute auction orders and catalog orders, respectively, that were generated within the electronic exchange network according to a second embodiment of the present invention; and

FIGS. 5a and 5b are schematic diagrams depicting a three-tiered security regime employed in preferred embodiments of the present invention.

### DETAILED DESCRIPTION OF THE PREFERRED EMBODIMENTS

Reference is now made in detail to the preferred embodiment of the present invention, examples of which are illustrated in the accompanying drawings.

In the following description of the preferred embodiments, auction bids according to the present invention are sometimes referred to herein as buyer bids because they are bids by which users of the electronic market attempt to buy the right to ship goods on particular shipping lanes of interest at auctioned rates in a seller's auction. Conversely, bids are sometimes referred to herein as seller bids because they are bids by which user of the electronic market attempt to sell the right to ship goods on particular shipping lanes of interest at auctioned rates in a buyer's auction. Reference to carriers and shippers (the terms being utilized interchangeably herein unless context suggests otherwise) herein in the detailed description should be interpreted broadly to include not only those entities offering to provide transportation services (broadly referred to as sellers henceforth), such as common carriers, but also entities, such as transportation brokers and the like, who represent carriers and sellers. Additionally, as the terms are herein used, shipping customers include anyone desirous of purchasing transportation services (broadly referred to as “buyers” henceforth). Thus, as will be appreciated by one skilled in the art, a carrier, shipper or transportation broker (i.e., one who is typically a seller) could at times operate as a buyer according to the present invention (e.g., when a seller offers excess capacity to other sellers in a wholesale-type auction).

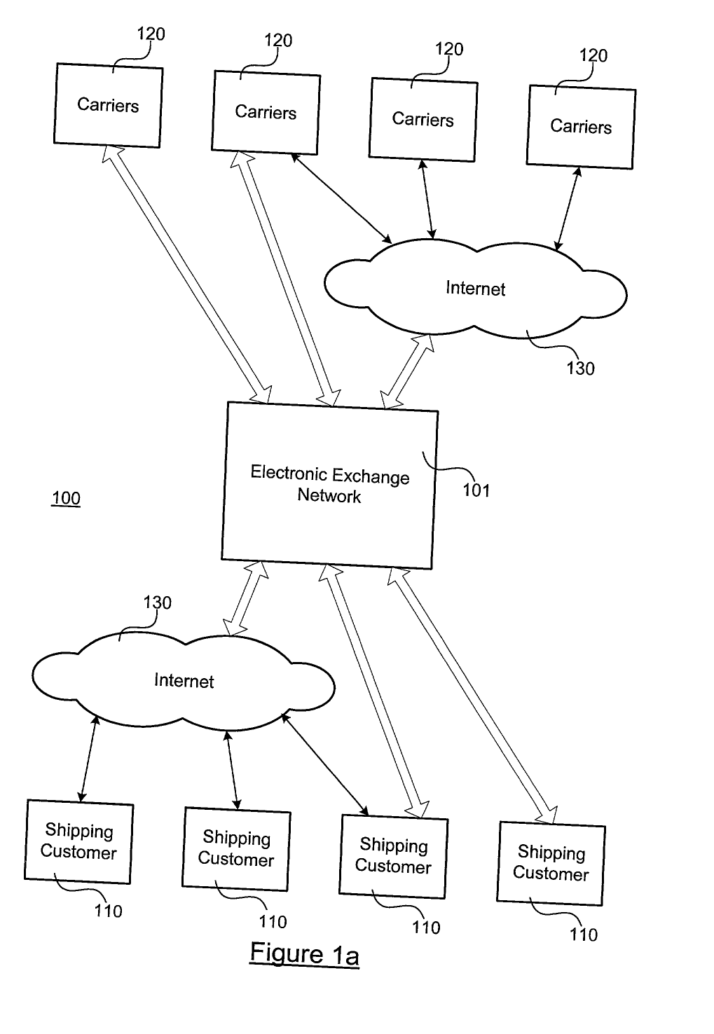

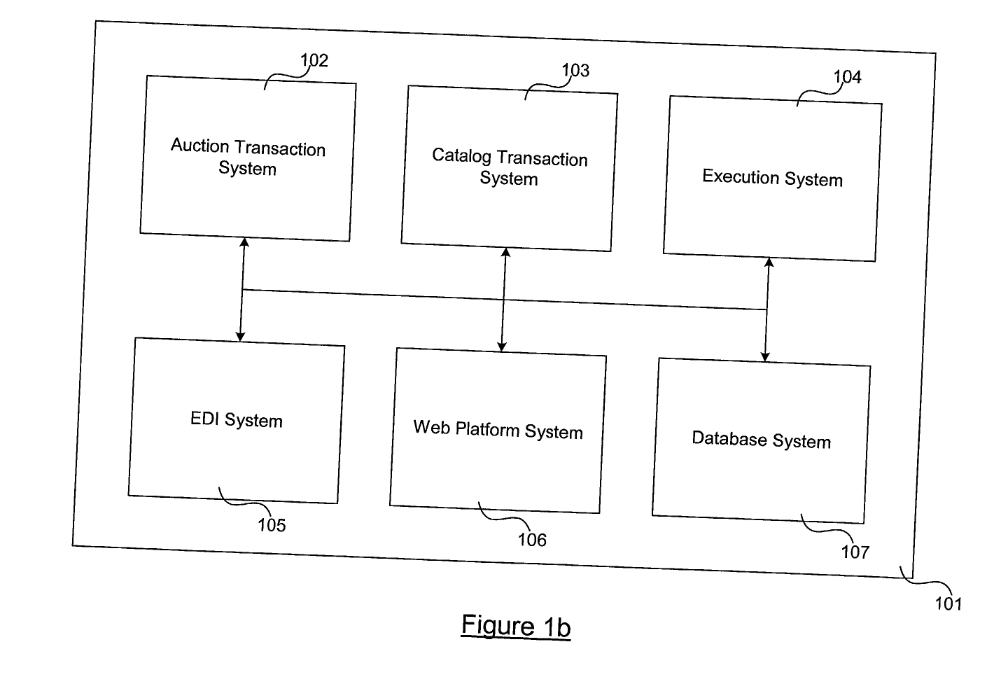

Referring to FIG. 1a, there is schematically depicted the inter-relation of the basic elements of an electronic market 100 according to embodiments of the present invention. Embodiments of the electronic market 100 according to present invention utilize various computing devices communicating over a distributed network with an electronic exchange network 101. In such preferred embodiments, the distributed network comprises the Internet 130. Users (carriers 120 and shipping customers 110 in the figure representing the computing systems of various sellers and buyers) may interact manually with an electronic exchange network 101 using client computing devices that permit client connections to the electronic exchange network 101 via web browsers over the Internet 130. Additionally, as shown in the figure, the computing systems carriers 120 and shipping customers 110 may communicate automatically with the exchange network 101 using various forms of EDI or like technologies.

Many carrier types are available in the transportation industry, and the best shipping mode for a given order varies dependent upon many factors including the kind of good, the size/weight of the freight, and desired delivery timelines. Typically, large and/or heavy materials with relatively remote delivery deadlines can be sent either on commercial or private fleet truck loads (“TL”) while medium size or medium weight freight movements can be accomplished using commercial or private truck carriers in a less than truck load (“LTL”) scheduling. Large to medium weight or size freight movements can also be accomplished over land via rail transportation or even air transportation. Large to medium size and weight freight movements, particularly for transcontinental shipments, can also be accomplished via sea barge. Additionally, one or more carrier types are often employed in combination to form an intermodal carrier route. A typical example would be for a large-weight shipment to be scheduled to run via TL carrier from the distribution center to a sea port and then transfer from the sea port oversea via transatlantic barge to Great Britain.

As will be readily appreciated by one skilled in the art, the electronic market 100 according to the present invention can be adapted to serve a variety of real-life shipping markets varying in geographic and service scope. For example, one electronic market could service all of the above-described types of carriers (TL common carriers, sea barge companies, air freight brokers, etc.), carriers catering to sellers within a particular industry (e.g., perishable goods), or similarly only deal in services offered by a single type of carrier (e.g., TL carriers). Similarly, markets can be established of varying geographic scope varying from wide geographic areas (such as the European continent) to carriers that specialize within limited geographic areas (such as the city of New York).

Furthermore, it will be readily appreciated by one skilled in the art that electronic markets 100 according to the present invention can greatly facilitate international marketplaces that comprise many buyers and sellers operating from remote locations in many different countries. Buyers and sellers can each operate individually in interfaces that operate according to the own language, currency, time zone, date and number formatting and units of measure and have those automatically converted into the language, currencies, etc., for the benefit of other buyers and sellers.

Referring now to FIG. 1b, there is schematically depicted an electronic exchange network 101 according to one preferred embodiment of the present invention. As shown in FIG. 1b, the exchange network 101 is comprised of a plurality of computerized systems in electronic intercommunication, including: an auction transaction system 102, a catalog transaction system 103, an execution system 104 (utilized only in the second embodiment of the invention as described below), an electronic data interchange (“EDI”) system 105, a web platform system 106 and a database system 107. Each of the systems 102-107 that form the exchange network 101 are comprised of suitable servers (computing devices), storage devices (including databases), memory devices and support hardware as is known in the art of computer networks to achieve the functions of each system 102-107 as hereinafter described.

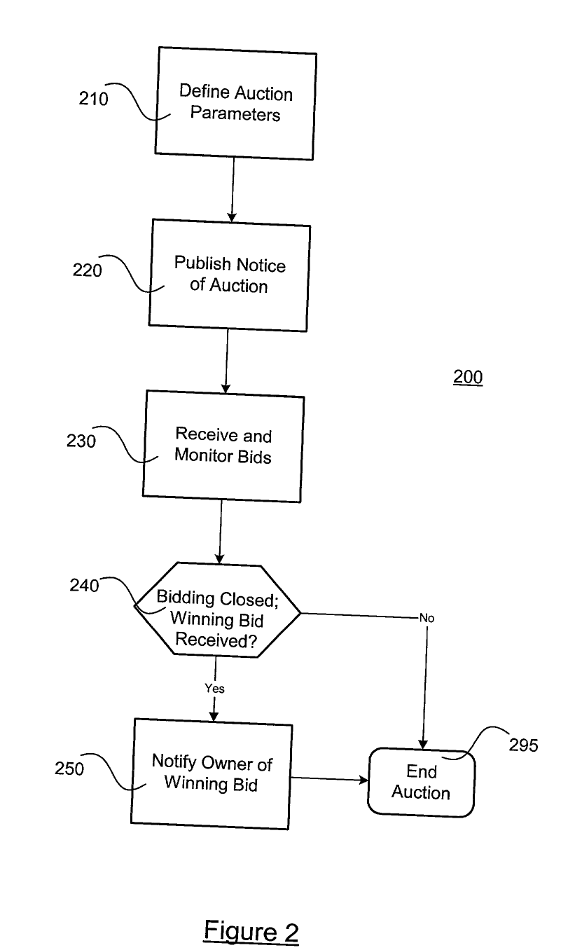

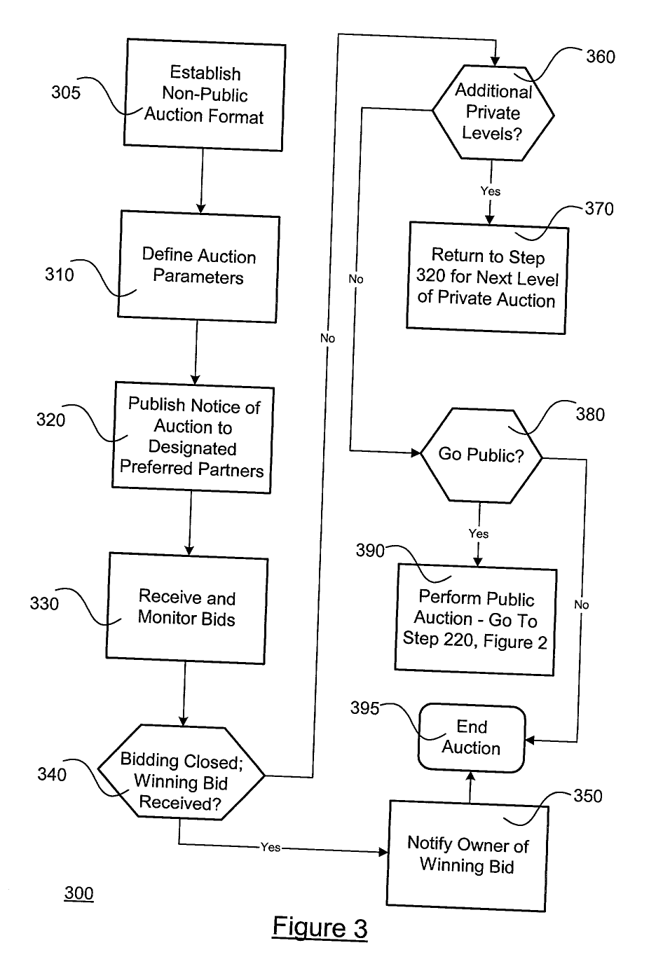

Auction transaction system 102 provides the processing power, support electronics and logic necessary to allow users to set up auctions, to conduct auctions according to rules set up by user, to accept bids, and to identify (either automatically or manually) winning bids and related bidders. As will be readily appreciated by one skilled in the art, private, multiple level private, private-public, and public auctions (which are described in detail below) administered by auction transaction system 102 in embodiments of the present invention can be performed under any auctioning bidding scheme known in the art. For example, a given auction can be open such that all users eligible to bid can view pending bids, or alternatively the bidding can be kept secret. Furthermore, traditional seller's auctions are permitted to let shippers auction off excess capacity as described above, while descending price auctions are permitted to allow sellers (i.e., shippers) to “bid” on shipping contracts requested by shipping customers in a buyer's auction. Finally, various auctioning rules can be set. For example, a rule could state that contracts are awarded to the highest bidder at a price lower than the highest bid (such as the second highest bid) so as to prevent buyer's remorse. Other rules could allow bidders to set maximum bids with automatic increments if prior bids are beaten, or allow bids to have a time expiration feature. Additionally, different rules could be selected by an auctioning user (the user requesting that an auction be held) for each level of a multiple level private auction or a private-public auction such that, for example, current bids are able to viewed by user that are able to bid in the private auctions while, once the auction transitions to a public auction, bids become secret. FIGS. 2 and 3, which will be described in detail below, illustrate the operation of the auction system 102 with respect to the handling of public and private auctions according to the present invention.

Similarly, catalog transaction system 103 provides the processing power, support electronics and logic necessary to allow sellers to post an electronic catalog-type listing of carrier services (lanes, equipment, delivery times, etc.) and related rates such that buyers can utilize the electronic market 100 to review and, in the second embodiment, purchase (and, optionally, monitor and issue payments/invoices) services at listed prices in combination with the execution system 104 as described below. These rates can be modified at any time by each seller user (such as periodically) and stored in the database system 107 for immediate publication and use by the catalog system 103 the next time a buyer user inquires into the price of services offered by that seller user. In preferred embodiments of the present invention, seller users can optionally provide multiple variable catalog rates for the same shipping services such that discounted rates can be provided to certain designated preferred catalog customers. Thus, in this manner, loyal repeat customers could be quoted lower catalog rates on one or more shipping services offered as compared to the catalog rates quoted to less frequent repeat customers. Similarly, in this manner sellers can provide special contract rates to the exchange network for use with specified buyers in recognition of pre-existing shipping agreements with those specified buyers. As will be readily appreciated by one skilled in the art, shipping carriers typically offer shipping services quoted in variable rates (fees which increase depending upon factors such as size/weight of the shipment, distance of shipment, etc.) for particular lanes, plus extra coincidental or one-time lane-related charges (such as, for example, port taxes, equipment type surcharges, etc.). A more detailed summary of the common form of such variable rates is provided below.

The database system 107 comprises one or more database servers and relational databases adapted to store its data in any manner known in the art, such as directly on a server hard drive, or remotely on external storage media including tape drives, CD-RWs and writable optical disks, and remote hard drives. This system is utilized by the exchange network 101 to store all shipping transaction data handled by the exchange network 101, such as catalog type rate tables for various shipping services offered by carrier users, auction bids, and pending electronic tender offers sent to carriers (as described below). Additionally, the database system 107 is adapted to store administrative information regarding the identity of all registered users (such as security permissions, etc) for use in authentication processes when users connect to the execution network 101 and attempt to access data or transact business with other users.

The web platform system 106, comprising one or more web servers, communicates directly with each buyer and seller user's computer (running a web browser application) via the Internet and retrieves and serves, in a suitable hardware independent page description language (such as HTML, XML, and java), requested data from the database system 107. This data can include, among others as is apparent from the balance of the accompanying description, live status information regarding in-progress auctions from the auction transaction system 102, quoted rates provided via the catalog transaction system, and live status information from the execution system 104 regarding shipping orders in the process of being executed. The web platform system 106 enables authenticated buyer users and seller users to use a standard web browser to request and view data relating to pending, in-progress, or completed catalog and auction transactions. Requested data is retrieved from the database system 107 and converted by the web platform system 106 with known front-ending methods into internet protocol (“IP”) formatted data, for example, via CGI scripts, Microsoft ASP, Java scripts or other like methods, and made available on the world wide web as an interactive dynamic web site (as described in detail below) for viewing and interaction with a web browser.

The interactive dynamic web site provided by the exchange network 101 is comprised of multiple web pages that enable the various users for each buyer and seller to have a remotely accessible intuitive interface with the exchange network 101. The web site includes individual or multiple secure web pages such as: a user login page for accessing the web site with a secure password and username pair, auction creation web pages for defining parameters of new auctions, auction participation web pages, catalog rate viewing pages, catalog rate maintenance pages, catalog rate inquiry pages, catalog rate order pages, seller information pages, and user preference and administration pages and the like. In this manner, users for each buyer and seller can conduct business in the electronic market 100 as described herein simply by having a computer running a web browser program and an Internet connection.

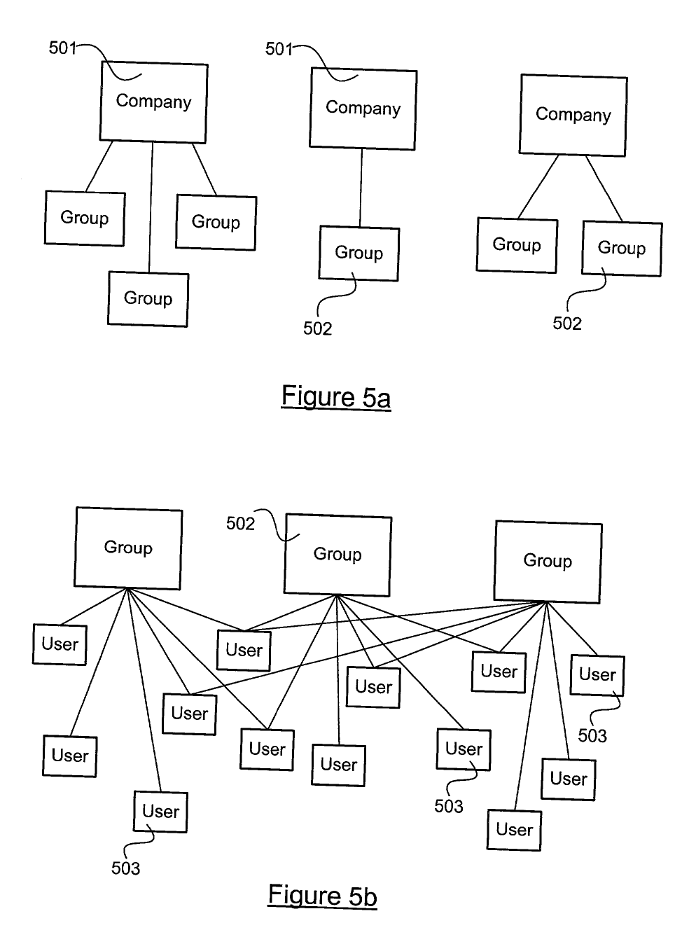

Retrieval of the information and data stored in the database system 107 via the web platform system 106 at the request of any user is controlled by standard authentication and authorization protocols. Sellers and buyers sign up to become members of the electronic market 100 and are each then able to establish one or more users accounts that each grant access to certain features of the dynamic web site while restricting others. Each user receives a username and password via which he or she can access desired information and, if given the proper permissions are associated with that user's account, conduct business via the electronic exchange network 101. Once a user has received an account, he or she is able to login into various secure web pages and be presented with dynamically generated web pages representative of the level of access that the user's particular account possesses (according to a security regime). In this manner, buyers and sellers can assign roles to each user account in parallel to that user's position and responsibilities with respect to the buyer/seller in the real world marketplace. Preferred security regimes and related user roles are discussed in more detail below with respect to FIGS. 5a and 5b.

As shown in FIG. 1b, the exchange network 101 according to the illustrated preferred embodiment of the present invention additionally contains an EDI system 105. Like the web platform system 106, the EDI system 105 is used by users representing both buyers and sellers to exchange data electronically between the exchange network 101 and the users' (carriers 120 or shipping customers 110) own computing devices (such as the private computer network of the buyer/seller). While the web interface provided by system 106 is designed to facilitate user-initiated electronic communication with the exchange network 101, the EDI interface provided by the EDI system 105 is designed to facilitate direct integration with the private electronic networks of each carrier, shipper or customer, etc., through standards-based electronic data interchange (“EDI”). The EDI system 105 is adapted to receive information electronically from carriers, preferably via LAN, WAN or the Internet, pertaining to the types of transportation services offered by the carrier as well as the rates that they charge for these services. This information includes travel lanes, equipment types, and rates for those lanes and equipment types and is stored in the database system 107 for later use in calculating quoted transportation costs for any services requested by a buyer. Similarly, EDI can be used to send tender offers and purchase orders to and receive acceptances from carriers after the closing of auctions or the submission of catalog orders. Additionally, tracking and tracing shipment status messages regarding the status of a shipment that was scheduled by a buyer and seller via the electronic market 100. Finally, the EDI system 105 can be used by buyers or sellers to download information into local planning and optimization systems. For example, a buyer could establish EDI protocols whereby carrier rate tables, track/trace, and billing information are automatically downloaded periodically into a local transportation planning system (such as, by way of example, that disclosed by U.S. patent application Ser. No. 09/882,257, filed Jun. 18, 2001, the specification of which is herein incorporated by reference in its entirety) resident on its private computer network. This downloaded information can then be used by the buyer to optimize its transportation efforts and expenditures.

The auctioning processes performed by the electronic exchange network 101, and in particular the auction transaction system 102 in preferred embodiments, will now be discussed in detail. FIG. 2 is a flow diagram depicting the method 200 utilized to conduct public auctions according to embodiments of the present invention. Once a buyer or seller that is a member of the electronic market 100 decides that it wants to conduct a public auction (accepting bids from any member of the electronic market), a user having proper authority first logs onto the exchange network 101 and defines 210 auction parameters using the dynamic web page interface. For standard seller's auctions, the auction parameters describe the transportation service being auctioned (including, for example, times for pickup and delivery, lanes, capacity in terms of either weight or cubic volume, equipment type, etc.) as well administrative details for the auction. The administrative details define when the auction takes place (beginning and end time), the type of bidding scheme (blind or open, bid format, whether the winner will be determined automatically by rule or manually by the auctioning seller upon review of bids, etc.) and optionally whether there is a minimum bid increment (in dollars per mile or in total dollars), a reserve price, or a strike price wherein the auctioned service is awarded to the first bidder that meets or exceeds the strike price. The electronic exchange network then publishes 220 a notice describing the auction and its time of occurrence to all users having permission to bid on seller's auctions. This publication step could be performed through various mechanisms, including email messages, facsimiles, broadcast notices published on a notices page in the dynamic web site supported by the web platform system, etc.

At the start time defined by the auctioning seller at step 210 the auction transaction system 102 commences the public auction and begins to receive and monitor 230 incoming bids from interested buyers. When a minimum bid price has been specified, the auction transaction system will reject all bids that fall below the minimum and can optionally instruct the erroneously bidding buyer accordingly. Similar actions can be initiated with respect to minimum increment violations. Specifically with respect to capacity auctions held by sellers, the auction transaction system further rejects bids that are over the auctioned capacity (either in terms of weight or cubic volume. Additionally, when the auction has open bidding the auction transaction system will allow the web platform system to publish the history of received bids (such as the time of each bid and that bid's price) as they are received. Thus, bidding buyers can decide to review the status of their bids and decide if they want to increase (or rescind, if allowed by the auction rules) their pending bid.

A bid in a seller's auction comprises at least two main components: an identifier of the bidding party (buyer/seller designation and preferably also the particular user account of the buyer/seller that submitted the order) and a bid price. If it is desired for the auction transaction system 102 to screen over-capacity bids, then buyer bids for a particular auction would also be required to describe the goods being shipped in either total weight, cubic volume, or both. In preferred embodiments, however, a bid can include various advanced items. Specifically, bids can be configured by a bidding user to automatically increase from the submitted bid amount (a base bid) until their bid is either the highest pending bid or until a maximum bid amount is reached. The bidding user would then include with their bid information regarding a maximum bid and a pre-selected bid increment amount that will be automatically triggered whenever the bid is not the highest bid. Understandably, however, this feature could be disallowed by the auction rules such as, for example, where secret bidding is employed. Additionally, in auctions wherein the winner is chosen manually, bidding users could optionally associate an expiration time with their bid such that the bid is automatically retracted if no winning bid is identified before the expiration time is reached.

At some point after the receipt of bids has been allowed at step 230, the auction transaction system 102 closes bidding 240 and decides if a winning bid has been received. According to the various embodiments of the present invention, the closing of the auction as well as the identification of a winning bid can transpire in many ways depending upon the auction parameters defined by the auctioning seller in step 210. For example, for a given auction, the winning bid may not be determined by a preset rule but may alternatively be selected by the auctioning user. In such a case, bids could be accepted for a predetermined time period and then submitted to the auctioning user after expiration of that time period for review and selection of a winner manually. Similarly, the auctioning user could manually select a winning bid from active bids while an auction is ongoing and thus also manually trigger the termination of the auction. For example, a user that initiates a seller's auction could manually designate two winning bids and join those two together to fill its auctioned capacity. Alternatively, in other types of auctions both the termination of the auction and the selection of a winning bid could be accomplished automatically as is the case where a strike price is set in the auction parameters in step 210 and then met by a valid bid received in step 230. Of course, as shown in FIG. 2, there can be situations wherein the auction is terminated at step 240 but no winning bid is received (such as, for example, because the auction timed out without a specified minimum bid being met), thus signaling the end of the auction 295.

In the event that a winning bid has been identified at step 240, the auction transaction system 102 notifies 250 the owner of the winning bid that its bid has won the auction. Like notices of an auction, this notification can comprise email messages, facsimiles, broadcast notices and equivalent notification means. The sending of the notification signals the end of the auction 295.

The manner in which public buyer's auctions are conducted is similar in most respects to the manner described above with respect to public seller's auctions. One notable exception is that in buyer's auctions bid prices will normally decrease as opposed to increase. Further, the information describing the auctioned service supplied by the auctioning buyer necessarily takes on a different format. For example, in the service description buyers would need to provide information regarding the goods to be shipped including weight and/size as well as other relevant information such as where, for example, those goods require specific equipment types such as temperature controlled containers. Further, a buyer would most likely describe the services desired by stating origin and destination locations (as opposed to stating a lane/geographic area).

FIG. 3 is a flow diagram depicting the method 300 whereby private, multiple level private, and private-public auctions (collectively hereinafter referred to as “non-public auctions”) are performed by the auction transaction system 102 according to preferred embodiments of the present invention. As seen by comparing FIGS. 2 and 3, method 300 for non-public auctions operates very much like a recurring nested version of method 200 for public auctions. In non-public auctions, however, the auction initiating user must provide a set of information to define what type of non-public auction the auction transaction system 102 should hold. As shown in FIG. 3, a non-public auction requires the auction initiating user to provide information to establish 305 the format of the non-public auction. This format information tells the auction transaction system 102 whether the non-public auction will potentially become public (could be triggered automatically by a rule established at step 305, or alternatively initiated manually by the auctioning user at steps 360 and 380 as described below), whether the non-public auction is a multiple level private auction, how many levels of preferred partners there are if it is a multiple level private auction, and the identity of preferred partners for each level of the private auctions. For each private auction level (for any non-public auction there will be at least one level of private auction) only users designated as preferred business partners by the user (such as initially at step 305, or later, as described below, at steps 360 and 380) may bid on the auctioned capacity of the particular shipper (in a seller's auction) or requested shipping order of a particular customer (in a buyer's auction). Users designated as preferred business partners can consist of, for example, default buyers/sellers designated by the auctioning party for all transactions (both catalog and auctions), just auction transactions, or only for that particular auction (at step 305). In this manner, a selling carrier, for example, can cater its services to particular users (e.g., repeat customers) and target market segments in an attempt to garner better prices. Similarly, in a buyer's auction a shipping customer can designate carriers who it knows has providing superior service in the past a preferred partners for its auctions.

Referring again to FIG. 3, in non-public auctions the auction initiating user next defines 310 auction parameters including a description of the transportation service being auctioned (times, origin and destination, capacity, equipment type, etc.) and administrative details for the auction (auction/bid type, minimum bids, start/end times, etc.). Optionally, at step 310 different auction parameters could be set for each established level of the non-public auction if multiple levels were defined prior to the auction at step 305. As will be better appreciated after reading the balance of the description with respect to FIG. 3, if multiple non-public auction levels and separate auction parameters are established in steps 305 and 310, additional input by the auction initiating used is not required during the auction. Optionally, of course, the auction initiating user could manually establish additional levels of private auction with customized auction parameters later at step 360, or could open up the auction to all members of the electronic market as a public auction with customized auction parameters later at step 380.

Like with method 200 employed for private auctions, method 300 employed for non-public auctions next publishes 320 a notice of at least the first level of private auction to the designated preferred partners who are eligible to bid in that private auction level. This notice describes the private auction level and its time of occurrence to all users of designated preferred partners that having permission to bid on auctions. As described above, this publication step could be performed through various mechanisms, including email messages, facsimiles, broadcast notices published on a notices page in the dynamic web site supported by the web platform system, etc.

At the start time defined by the auctioning user at step 310 the auction transaction system 102 commences the private auction first level and begins to receive and monitor 330 incoming bids from interested users that were designated as preferred partners. As with public auctions, the auction transaction system 102 performs various functions while receiving and monitoring bids as required by the auction preferences and rules set by the auction initiating user. For example, in the event that a user not designated as a preferred partner by some way learns of the non-public auction and attempts to enter a bid at step 330, this bid will be rejected. Similarly, bids in the various levels of a private auction comprise at least a bid price and an identifier of the bidding buyer or seller plus other necessary information as well optionally contain advanced items such as automatic bid incrementing, expiration and the like.

At some point after the receipt of bids has begun at step 330, the auction transaction system 102 closes bidding 340 for the first private auction level and decides if a winning bid has been received. As with step 240 of the method 200 for conducting private auctions, in the various embodiments of the present invention the closing of the initial private auction level as well as the identification of a winning bid can transpire in many ways depending upon the auction parameters defined by the auctioning seller in step 310. These decisions can be implemented automatically by the auction transaction system according to preset rule, or be initiated/selected manually by the auctioning user.

In the event that a winning bid has been identified at step 340, the auction transaction system 102 notifies 350 the owner of the winning bid that its bid has won the auction, and the sending of this notification marks 395 the end of the non-public auction. This notification can comprise email messages, facsimiles, broadcast notices and equivalent notification means.

If no winning bid is identified (either manually or automatically) at step 340, the auction transaction system determines 360 whether additional private auctions levels remain, i.e., whether the current non-public auction should continue as a multiple level private auction. As discussed above, in advance of step 360 when establishing the non-public auction format and defining the auction parameters (including the designation of preferred trading partners) at steps 310 and 320, the auctioning user could have designated more than one set of preferred partners with each such set naming the parties who can participate in each level of the requested multiple level private auction. For example, set 1 naming buyers A, B, C and D would be eligible for the initial private auction level, set 2 naming buyers E, F, G, H and I would be eligible for the second private auction level (optionally either in addition to set 1 or at the exclusion of set 1), and so on.

If several ordered sets of preferred partners are indeed named, method 300 recognizes that an additional private level of auction is necessary and proceeds to return 370 back to step 320 and then repeat steps 330, 340 and 360 substantially as described above. In this manner, notice is published 320 to all new preferred partners eligible to enter bids, bids are received and monitored 330, and bidding is closed and a determination 340 is made as to whether a winning bid was received. If a winning bid is received, the auction transaction system 102 notifies 350 the bid owner and the auction ends 395 (without opening the auction to any other lower sets of preferred partners or having a public auction). This process thus repeats steps 320-370 to provide a private level auction for each ordered set of preferred partners (in the order specified by the auctioning user) until either a winning bid is identified at step 340 or until all levels of the private auction have been exhausted.

As with the determinations at step 340 as to when to stop receiving bids and whether a winning bid has been received, the determination at step 360 as to whether additional private auction levels are necessary can be handled both automatically by the auction transaction system 102 according to the auction format and auction parameters set up by the auction initiating user, or can be made manually by the auction initiating user.

If no additional levels of private auction are identified, the auction transaction system 102 determines 380 whether the auctioned transportation services should be offered in a public auction. As made clear by FIG. 3, therefore, if no winning bid has been identified after the bidding is closed at step 340, a private auction containing only one private auction level and not authorized to be opened up to all buyers and/or sellers as a public auction will be considered to have ended (step 395). Similarly, if no winning bid has been identified at step 340 in the last level of a multiple level private auction and it is then determined at step 380 that the auctioned transportation services will not be made available in a public auction then the auction will have ended (step 395).

Finally, at step 380 if it is determined that the private auction or multiple level private auction should be opened to the public, the auction transaction system 102 performs 390 a public auction according to method 200 as specified by FIG. 2. Specifically, the auction transaction system 102 publishes notice of the public auction to all buyers and/or sellers (step 220), receives and monitors bids for a certain period of time (step 230), ends bidding and determines whether a winning bid was received (step 240), and if so, notifies the owner of the winning bid (step 250) before terminating the public part of the auction (step 295).

Again, similar to the determinations at steps 340 and 360 as to when to stop receiving bids, whether a winning bid has been received, and whether additional private auction levels are necessary, the determination 380 as to whether a public auction should be held can be made both automatically by the auction transaction system 102 (according to preset rules) or made manually by the auction initiating user. Finally, it should be readily understood by one skilled in the art that the manner in which non-public buyer's auctions are conducted is similar in all substantial respects to the manner in which non-public seller's auctions are conducted.

The catalog transaction system 103 in the exchange network 101 is adapted to allow sellers to post an electronic catalog-type listing of carrier services (lanes, equipment, delivery times, etc.) and related rates and then allow buyers to review and potentially submit purchase orders for those services at those listed catalog rates. These catalog rates can be modified at any time by each seller user (such as periodically) and stored in the database system 107 for immediate publication and use by the catalog system 103 the next time a buyer user inquires into the price of services offered by that seller user.

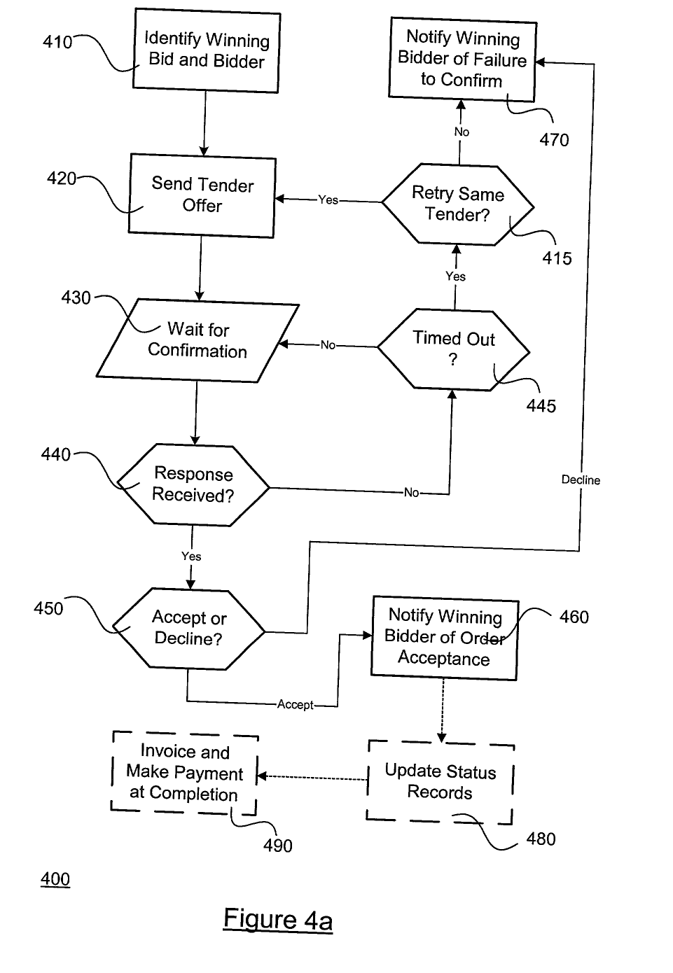

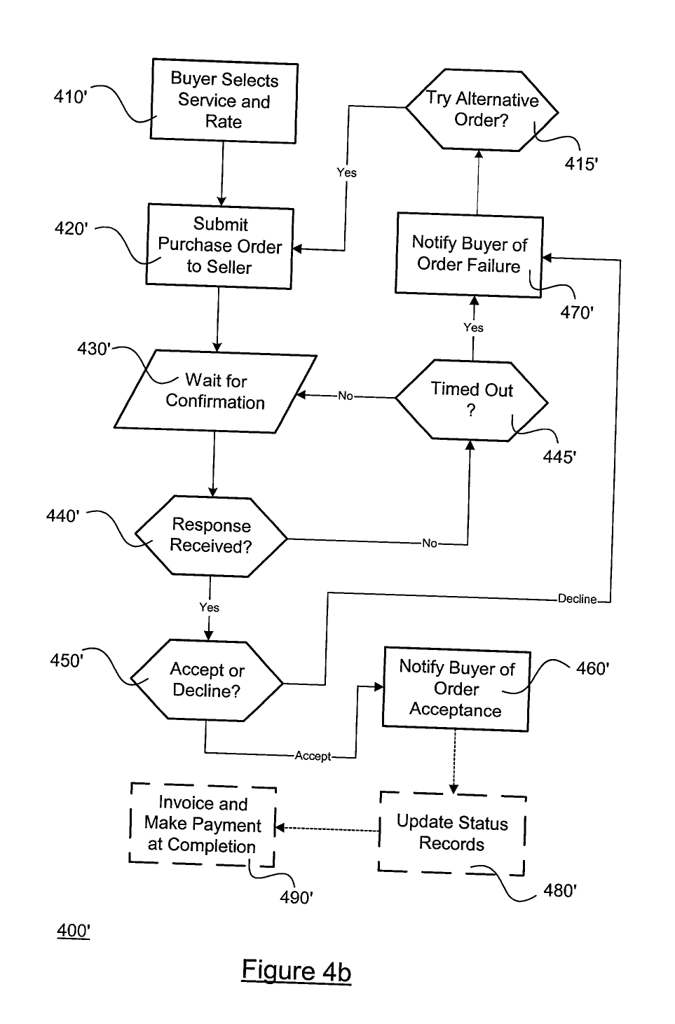

According to embodiments of the present invention, a buyer user can review posted catalog rates, and then possibly enter a purchase order based upon those rates, according to one of three alternative mechanisms. First, a buyer can directly inquire as to the catalog rates of a particular seller in the electronic market 100. This can be accomplished, for example, by navigating within the electronic market's dynamic web site directly to a web page or pages having a listing of all services and quoted rates currently offered by that seller. The seller can then manually review the services and associated catalog rates and, if so desired, select an appropriate service and rate for the submission of a purchase order to the seller (performed by the execution system 104 according to the second embodiment of the present invention as described below). Second, a buyer can search the type of and rates for transportation services offered by one or more particular sellers in the electronic market 100. For example, the buyer could identify the seller in which it is interested (such as by navigating within the electronic market's dynamic web site directly to a web page or pages having a listing of all services and quoted rates currently offered by that seller or simply by identifying the seller by name) and then specify search parameters (such as via a web-based form provided by the interactive web site) to initiate a service and rate inquiry search by the catalog transaction system 103. If the buyer is potentially interested in reviewing the rates of more that one carrier, the interactive web site enables interaction with catalog transaction system 103 to perform a service and rate inquiry search among multiple sellers (including all sellers within the electronic market 100) for a specific type of services and compare relative rates for suitable alternative service offerings. Third, a carrier could ask the catalog transaction system 103 to search and automatically assign the “best” service and rate for a shipment performed a particular carrier for its desired service and then automatically submit a purchase order for the service at that rate via the execution system 104 (as described below with respect to FIG. 4b). In this manner, carriers can be pre-assigned by the buyer (such as when the buyer is contractually obligated to use a particular carrier or when, for example, the buyer knows that the particular carrier offers the best service) and the catalog transaction system 103 and execution system 104 can work in tandem to automate the submission of a purchase order as described below.

Service and rate inquiry requests (whether for a single seller or multiple sellers) received by the catalog transaction system 103 (via either the EDI system 105 or web platform system 106 depending upon how the buyer is accessing the exchange network 101) must have at least one origin/destination pair. Additionally, each inquiry includes all the information that the logic employed by the catalog transaction system 103 needs to identify the appropriate rate. Generally, this information can be conceptualized as being divided into three parts which include header information, shipping units information, and routing information. The header information contains administrative data that, for example, identifies when and from where (which customer user) the order was received. The shipping units information identifies the type of product to be transported, the physical dimensions of the product (including length, width, and height), number of units and weight of each unit. The routing information provides detailed origin and destination locations as well as time windows for pickup and delivery.

The catalog transaction system 103 then, using carrier rate tables stored in the database system 107, calculates a quoted cost for the service and rate inquiry and quotes that cost to the appropriate buyer for review and ultimately either acceptance or rejection. In situations where more than one offered service meets the buyer's inquiry parameters (often the case where multiple sellers are listed in a single inquiry), the catalog transaction system 103 provides a report to the inquiring buyer comparing the possible services. If the quoted cost for one of the returned services is accepted by the buyer, according to the second embodiment of the present invention, automatic execution that order is performed by the execution system 104 substantially according to method 400′ illustrated by FIG. 4b (described below).

Further, the catalog transaction system can be configured (either by default exchange network rules or by the parameters of a buyer's services inquiry) to consider quoting multiple leg shipments in response to the inquiring buyer. Such multiple leg shipments would combine three individual service routes (and the associated rate for those routes) which comprise a first truckload shipment route from the pick-up location to a railroad depot (or sea port/airport), transport via rail (or sea/air) to a second railroad depot (or sea port/airport), and then a second truckload shipment to the destination. Specific systems and methods for constructing potential three-leg shipments are fully disclosed by U.S. patent application Ser. No. 09/882,257, filed Jun. 18, 2001, the specification of which having previously been incorporated by reference in its entirety above.

In preferred embodiments of the present invention, sellers can optionally provide multiple variable catalog rates for the same shipping services such that discounted rates can be provided to certain designated preferred catalog customers. In this manner, sellers can offer reduced rates to specific buyers based upon pre-existing business relationships. Inquiries from such preferred catalog customers are recognized (such as by reviewing the header information of the service and rate inquiry) and quotes are provided accordingly. Similarly, a user that navigates within the electronic market's dynamic web site directly to a web page or pages having a listing of all services and quoted rates currently offered by a seller would, if that seller lists the user's organization as a preferred catalog customer, automatically be recognized and provided with appropriately discounted rates. As will be readily appreciated by one skilled in the art, preferably, multiple levels of preferred catalog customers can be employed such that loyal repeat customers could be quoted lower catalog rates on one or more shipping services offered as compared to the catalog rates quoted to less frequent repeat customers (who in turn could optionally be quoted a lower rate than the average customer).

Although not shown in FIGS. 1a or 1b, the exchange network 101 could also be provided with a means for calculating distances between the origin and destination of a shipping order. It is commonplace in the shipping and transportation industry that the rates quoted by carriers and other sellers often depend upon the distance for which the order has to be transported. To this end, the catalog transaction system 103 will need a manner for determining the distance between an origination and destination point itemized within each order. Therefore, the exchange network 101 could utilize an interface for electronic communication with a distance calculating program, such as known, commercially available programs like MileMaker or PC*Miler.

In embodiments of the invention, the rates for each seller's shipping services are specified in a plurality of tables which are stored in the database system 107 for retrieval and use by the catalog transaction system 103 and, in the second embodiment of the invention as disclosed below, by the execution system 104 for use calculating incurred fees (as described below). Such rate tables are stored therein for each carrier type, including truckload (“TL”), less than truckload (“LTL”), railroad, air, and sea transporters.

By way of illustration, the rate tables for most carrier types typically depend upon one of two variables (or sometimes both), distance from origin to destination and weight of the freight. Of course, it should be readily appreciated by one skilled in the art that carriers of the same type may employ various differing rate determination methods.

TL shippers (as well as LTL shippers) typically specify individual shipping rates for each equipment class (open truck, refrigerated container, etc.) offered. With respect to rates based upon distance traveled, the TL shippers typically quote in terms of five types of rating methods for TL shipments. They are flat rate, metric rate, fixed plus variable rate, mileage rate, and radial rate. A radial rate is a freight rating and routing method by which freight movement cost is determined using the sum of straight-line distances between each end point on a freight movement's various legs as the distance variable. The rate is then specified in each table in terms of a function based upon a dollars per mile factor, a minimum rate, and/or a flat rate.

LTL rates are specified by carriers for each class in terms of a minimum rate and weight breaks. Package rates are specified for a carrier's weight breaks and charges for transportation within a particular zone. (The zones being defined by a particular carrier). Rail rates, air rates and package rates can be defined as a combination of any of the above. Intermodal freight movements are rated using a particular carrier type rating tables for each leg of the trip.

With respect to the weight variable used in each of the rate tables, the catalog transaction system 103 supports the use of standard weights (i.e., pounds or kilograms) or dimensional weights. In the transportation industry, a dimensional weight is a calculation of the shipment's weight based upon its volume metric standard in addition to its actual weight. Essentially, it acts as a equalizer to ensure that large and bulky, yet lightweight, objects that consume a large portion of a carrier's capacity costs comparatively as much as a more dense yet smaller object.

Carriers typically require that their rate be determined using the larger of the two weights, that is the dimensional weight or the actual weight of the shipment, to determine the price that they charge. Dimensional weight rating is particularly applicable to industries, such as the high tech industry, wherein many boxes are shipped that each have a fairly low weight. For a multiple-package shipment, a dimensional weight is simply determined by adding the individual dimensional weights for each package together.

Additionally, both TL and LTL carriers often provide discounts to hauls that serve as a roundtrip. This helps to limit empty legs by carriers and the carriers therefore often pass their savings on to customers to promote roundtrip bookings. Additionally, it is common for rate tables of transportation services to take into account extra coincidental or one-time lane-related charges (such as, for example, port taxes, equipment type surcharges, in-transit handling fees, fuel surcharges, and import/export charges). For each type of carrier and/or lane and/or location, these extra charges are similarly defined within the database system 107. After the appropriate rating is calculated for the shipment based upon the carrier, the carrier type, and any appropriate modifications required by roundtrip rating, radial rating, dimensional weighting, etc., the extra charges that apply are added on to the end to produce a final quoted cost.

Rail carriers are very similar to TL type carriers in that they often operate seven days a week and their quoted rates (as stored in the database system 107) are typically specified in the same manners as they are with respect to TL (a rate based solely on distance traveled for an entire trailer and/or rail car). As will be readily appreciated by one of ordinary skill in the art, the use of rail carriers necessarily requires posted rail schedules determine the timing of a particular freight movement rather than distance and driving speeds. Additionally, the use of rail also precludes multiple stops or detours. Logically, intermodal carriers combining rail with TL carriers would necessarily incorporate all the limitations associated with TL and rail carriers. Sea carriers are similar to rail carriers in the respects mentioned above.

With respect to TL and LTL rate tables as described above, the catalog transaction system 103 must be able to determine a calculated distance that the shipment will travel from the origin to its destination in order to provide an accurate rate quote. As will be readily appreciated by one of ordinary skill in the art, the catalog transaction system 103 can be readily adapted to handle service and rate inquiry requests that specify shipment origins and destinations in a variety of forms including latitudes and longitudes, zip codes, or street addresses by performing necessary conversions with a readily available commercial distance calculation software such as the aforementioned PC*Miler and MileMaker programs.

When performing a service and rate inquiry at the request of a buyer, the catalog transaction system 103 performs an automated query that determines which carriers are possible to service the particular order which essentially takes the resources specified by the seller (or sellers) as being available searches the services offered by carriers for matches within relevant lanes. By way of explanation, a large freight order that needed to be moved via truck load from New York to Los Angeles could not use a TL carrier that only operated in the southeast United States. In performing this query, the catalog transaction system 103, in additional to geographic service area compatibility, considers: time windows (such as by hour of the day across the week) such that the carrier's quotes are active for the pickup and delivery times specified in the inquiry request and whether the carrier has compatible equipment to service a particular order or location (such as where the carrier needs a refrigerated car to transport perishable food goods).

According to a second embodiment of the present invention, the electronic market and related methods not only allows buyers and sellers to conduct auctions and to publish, search and review catalog shipping rates in a distributed network environment, but also enables the automatic tendering of shipment requests (after the closing of auctions or after quoting of catalog rates) to carriers and automates the monitoring of acceptances, also preferably transmitted electronically, from those carriers. FIG. 4a depicts the method 400 whereby the execution system 104 enables the automatic execution of an auction order (i.e., the winning bid) that was submitted into an electronic exchange network 101 according to the second embodiment of the present invention. (Optional steps of method 400 being indicated in broken lines.) Similarly, FIG. 4b depicts the method 400′ whereby the execution system 104 enables the automatic execution of an catalog order (i.e., the winning bid) that was submitted into an electronic exchange network 101 according to the second embodiment of the present invention. (Optional steps of method 400′ being indicated in broken lines.)

As seen in FIGS. 1a and 1b, the execution system 104 is electronically connected to carriers 120 either directly (such as through the dedicated communication lines of a LAN/VAN) or indirectly via the Internet 105. The execution system 104 is adapted to transmit tender offers (formal requests for shipping services) to the carrier(s) for any potential shipment represented by any completed seller's auction and to send purchase orders for any catalog order submitted by a buyer. Preferably, each carrier 120 that is a member of the electronic market 100 is electronically connected to the electronic exchange network in a manner that will allow tender offers (as a result of auctions) and purchase orders (as a result of catalog inquiries) to be sent automatically in electronic fashion through EDI, email or the Web immediately after the catalog order or seller's auction is finalized. Alternatively, of course, means such as facsimile or telephone can be employed to transmit such tender offers. However, it is preferable that the tender and purchase order processes are electronically automated.

Once received, carriers can review tender offers and electronically provide an acceptance or decline of the tender offer to the execution system 104, again preferably electronically via EDI or the Web. As with tender offers and purchase orders, the acceptance/decline can also alternatively be transmitted in more traditional means. If the tender offer or purchase offer is confirmed by the seller, than the transaction has been successfully executed according to the second embodiment of the present invention.

Referring specifically now to FIG. 4a, method 400 performed by the execution system 104 enables the automatic execution of an auction order by first, after the closing of a successful (i.e., one in which a winning bid is identified) public or non-public auction, identifying 410 the winning bid and bidder. The terms of the winning bid, in addition to the identity of the winning bidder, is utilized create and send 420 a tender offer to the seller (or buyer if the winning bid results from a buyer's auction). This tender offer identifies the subject transportation service for the auction (such as with a description of the transportation service or with an auction identifier and provides the identity of the bidder and terms of the bid. As described above, preferably this tender offer comprises an automated electronic communication in the form of an EDI or email message. The execution system 104 then waits 430 for confirmation (such as in the form of an acceptance or decline communication) that the seller has received the tender offer. If a determination 440 is made that the confirmation message has been received, the execution system 104 determines 450 whether the message communicated an acceptance or decline on the part of the seller. If the confirmation message is an acceptance, the execution system 104 notifies 460 the winning bidder (such as with an email message) that the carrier has accepted the tender offer, preferably in the form of a confirmation number and/or shipping order number issued by the seller and provided within the tender acceptance communication.

In the event that a confirmation communication is received but it is determined at step 460 that the seller has declined the offer, the execution system 104 notifies 470 the winning bidder (such as with an email message) of the failure of the seller to confirm acceptance of the tender offer resulting from the auction. As shown in FIG. 4a, in the event that a long time elapses before the seller sends a confirmation message in response to the tender (or never responds at all, such as, for example, if there was an electronic communication interruption), the execution system 103 can determine 445 if the chance for the seller to respond has timed out, and, if so, determine 415 if a second tender offer should be sent (i.e., return to step 420 and repeat the confirmation process).

Preferably the entire process beginning at step 410 and ending at either steps 460 or 470 is completely automated by the exchange network 101 and is initiated automatically immediately after the conclusion of a successful auction.

The method 400′ depicted by FIG. 4b whereby the execution system 104 enables the automatic execution of a catalog purchase order is similar in most respects to method 400 except that it requires manual interaction by a buyer. First, after researching services from sellers as described above with respect to FIG. 3, the buyer selects 410′ the desired service (and associated rate) that it wants. The buyer then submits 420′ a purchase order to the quoting seller for the desired service. This purchase order identifies the desired service (by the seller's catalog listing) and provides sufficient information to identify the services needed (this information being equivalent in content to the type provided in a service and rate inquiry). Preferably, purchase orders are electronically transmitted to the appropriate seller in the form of an automated electronic communication (such as an EDI or email message). The execution system 104 then waits 430′ for confirmation (such as in the form of an acceptance or decline) that the seller has received and reviewed the purchase order. If a determination 440′ is made that the confirmation message has been received (such determination being made due to, for example, the reception of a response communication), the execution system 104 determines 450′ whether the message communicated an acceptance or decline on the part of the seller. If the confirmation message is an acceptance, the execution system 104 notifies 460′ the buyer (such as with an email message) that the carrier has confirmed and accepted the tender offer, and preferably provides the buyer with a confirmation number and/or shipping order number issued by the seller.

If a confirmation communication is received but it is determined at step 460′ that the seller has declined the offer, the execution system 104 notifies 470′ the winning bidder (such as with an email message) of the failure of the seller to confirm acceptance of the purchase order submitted at step 420′. Preferably, a failure notification at step 470′ preferably communicates to the buyer a reason for the purchase order failure (not response from the carrier, carrier declined because requested pick-up time was not available or it had insufficient capacity available, etc.). This failure reason information then can be used at step 415′ by the buyer in deciding whether or not to try and submit an alternative purchase order. As shown in FIG. 4b, method 400′ also employs a time out feature at step 445′, to determine if the buyer should be notified 470′ of the carriers failure to confirm receipt of the purchase order.

Furthermore, it is preferred that in the second embodiment of the present invention the execution system 104 additionally provides electronic tracking and tracing functionality (this optional step being shown to occur after steps 460 and 460′ in broken lines in FIGS. 4a and 4b) that provides subscription based notifications to users for buyers who have executed shipping transactions as described above. With this subscription based tracking and tracing functionality of this preferred embodiment, users of the electronic market (assuming they have been granted the proper permissions by the buyer in the transaction) can log on to the interactive web site and obtain a detailed real-time shipping manifest including the present status or location of any shipment previously scheduled through the electronic market as well as previous locations and statuses. Any authorized user can additionally subscribe in such preferred embodiments of the electronic market and related method to receive notifications, preferably in the form of automatically generated emails, when a given shipment that is the subject of a shipping transaction reaches a particular location or obtains a particular status. For example, a company who is a participant in the electronic marketplace according to the present invention may have many employees who are registered users. A first registered user who is in sales may subscribe to receive an automatic email notification when a given shipment reaches its destination so as to serve as a reminder to place a follow-up phone call with the recipient. A second and third registered users may subscribe to be notified if the shipment is delayed (does not reach a particular location or status by a particular time) such that remedial measures may be taken.

When the execution system 104 is adapted to provide tracking and tracing information to buyers, it has a shipment status interface (not shown in the figures) for use by the sellers to convey real-time or near real-time information regarding the status of shipments in transit. At steps 480 and 480′, the status information transferred into the execution system 104 via its shipment status interface provides updates regarding shipments that are either scheduled for delivery (as the result of an accepted tender offer or purchase order) or en route. These updates can include when the carrier expects the route to leave, when the route has left a distribution center, when the route has arrived at a particular crossdock, warehouse or distributor, as well as expected delays either at the carrier end or at the location end. The execution system 104 then provides the status updates to the database system 107 where it is stored and made accessible to customers via the interactive web site provided by web platform system 106. Alternatively, in addition to being sent to the database system 107 for storage, status updates can be routed directly to users using via EDI system 105. In this manner, buyers and sellers can exchange track and trace information automatically into their internal optimization and planning systems.

When status updates are sent in real time from a carrier during steps 480 and 480′, as described above these messages can be used to cause execution system 104 to trigger alarm generation and subscription based status notifications. Such alarms and notifications, for example, can be used to send shipment update emails to one or more buyer users such as a buyer user serving a role as a transportation planning manager, a buyer user who is a sales office employee, etc.

Additionally, it is further preferred that in the second embodiment of the present invention the execution system 104 is linked to the billing accounts payable/receivable process of buyers and/or sellers. In this manner, a bill generation/payment electronic data interchange (“EDI”) event could be automatically triggered to the proper seller's/buyer's remote accounts receivable/payable computer systems when a shipment reaches its destination for payment on delivery transactions. Additionally, interfaces with the accounts payable and receivable systems of particular buyers and sellers can be utilized to factor in credit limits and available credit in the determination of whether to accept or reject tender offers and purchase orders. This final optional step in the execution of auction originating and catalog originating transactions is indicated in FIGS. 4a and 4b as steps 490 and 490′, respectively.

Specific systems and methods for implementing electronic tracking and tracing of various shipments while in route and for integrating automated invoice generation and bill payment are fully disclosed by U.S. patent application Ser. No. 09/882,257, filed Jun. 18, 2001, the specification of which having already been incorporated by reference in its entirety above.

As shown in FIGS. 5a and 5b, according to preferred embodiments of the present invention the exchange network 101 employs a three-tier security regime to help manage roles and responsibilities of the various users for each buyer and each seller. This three-tier preferred security regime distinguishes between companies 501 (buyer or seller), groups 502, and users 503. Groups 502 are subsets of companies 501, and users 503 are subsets of companies 501 and/or groups 502. As demonstrated in FIGS. 5a and 5b, each group 502 and user 503 may only belong to one company 501, but any user 503 can be associated with more than one group. In this manner, rights and permissions can be assigned on a company 501, group 502, and user 503 basis to assist in the security maintenance process. Thus, for example, a particular buyer company could establish its roles such that only one user would have the authority to initiate auctions, only users who are members of a first particular group can submit purchase orders via catalog transactions, and only users who are members of a second particular group can submit buyer bids in seller's auctions. Simultaneously, however, all users of the buyer company could be granted permission to review tracking and tracing information for scheduled and in transit shipments.

In alternative preferred embodiments, additional tiers to the security regime can be provided to enable collaborative efforts between separate companies. This fourth tier would be above the company level and take multiple users 503, groups 502 and/or companies 501 as members. Thus, while groups 502 and users 503 could only be members of one company 501, they could be members of more than one collaborative venture. Roles and responsibilities for each user of the venture can then be allocated similar to the manner described above with respect to the three tier regime of FIGS. 5a and 5b.

One of ordinary skill in the art will appreciate that the above optimization, execution and payment handling algorithms may be modified to take into account specific needs and/or problems encountered in particular industries or situations. Thus, the illustrative algorithm should not be construed to limit the present invention as is claimed.

Although the present invention is preferably implemented in software, this is not a limitation of the present invention as those of ordinary skill in the art can appreciate that the present invention can be implemented in hardware or in various combinations of hardware and software, without departing from the scope of the invention. Modifications and substitutions by those of ordinary skill in the art are considered to be within the scope of the present invention, which is not to be limited except by the claims that follow.

The foregoing description of the preferred embodiments of the present invention has been presented for the purposes of illustration and description. It is not intended to be exhaustive or to limit the invention to the precise form disclosed. It will be apparent to those of ordinary skill in the art that various modifications and variations can be made to the disclosed embodiments and concepts of the present invention without departing from the spirit or scope of the invention. Thus, it is intended that the present invention covers the modifications and variations of this invention provided that they come within the scope of any claims and their equivalents.

What is claimed is:

1. An electronic market for negotiating transactions regarding the exchange of transportation services between buyers and sellers, said electronic market comprising:
an auction transaction system, said auction transaction system being adapted to enable any one of said buyers or said sellers to conduct auctions for the exchange of transportation services;
a catalog transaction system in electronic communication with said auction transaction system, said catalog transaction system being adapted to enable said buyers to post quoted rates for various transportation services such that buyers may review quoted rates associated with desired transportation services; and
means for said buyers and sellers to communicate with said auction transaction system and said catalog transaction system, said means for communicating be adapted to enable said buyers and said sellers to interact through said catalog transaction system and said auction transaction system, and said buyers and said sellers being capable of designating selected other buyers and sellers as preferred trading partners with said auction transaction system or said catalog transaction system, and wherein said quoted rates and said auctions can be optionally made available to only said preferred trading partners.

2. The electronic market according to claim 1, further comprising an execution system in electronic communication with said auction transaction system and said catalog transaction system, said auction system allowing buyers and sellers to execute shipping transactions negotiated by said auction transaction system and said catalog transaction system.

3. The electronic market according to claim 2, wherein said catalog system allows an inquiring buyer to identify appropriate shipping services from said posted quoted rates for a desired shipment and said execution system sends electronic purchase orders to sellers associated with said select ones of said appropriate shipping services at the election of said inquiring buyer.

4. The electronic market according to claim 2, wherein said auction shipping system allows an auction initiating party to identify winning bids for transportation services being auctioned and said execution system automatically sends electronic tender offers to said auction initiating party detailing said winning bids and associated bidders.

5. The electronic market according to claim 4, wherein said auction initiating party can electronically accept or decline said electronic tender offers.

6. The electronic market according to claim 2, wherein said execution system receives status update messages regarding scheduled and in transit shipments and said communication means enables said buyer and sellers to review said status update messages.

7. The electronic market according to claim 6, wherein in response to receiving certain status update messages said execution system initiates commands to a remote private network of a selected buyer or seller.

8. The electronic market according to claim 7, wherein said command is utilized by said private network to trigger accounting transactions regarding said scheduled and in transit shipments.

9. The electronic market according to claim 7, wherein said command comprises email messages directed to individuals associated with said selected buyer or seller and said email reports relevant status information to said individuals based upon roles assigned to each of said individuals.

10. The electronic market according to claim 1, wherein said auction transaction system further enables buyers or sellers designated as preferred trading partners to bid in non-public and public auctions while those buyers not designated as preferred trading partners can bid only in public auctions.

11. The electronic market according to claim 10, wherein said auction transaction system further enables an auction initiating party to hold an auction that comprises a plurality of levels wherein a first level begins said auction as a non-public auction and a final level completes said auction as a public auction.

12. The electronic market according to claim 10, wherein said auction transaction system further enables an auction initiating party to hold a non-public auction that comprises a plurality of levels wherein said designated preferred trading partners differ for each level of said non-public auction.

13. The electronic market according to claim 12, wherein said auction initiating party has the option of transforming said non-public auction into a public auction if no winning bid is submitted by said designated preferred trading partners.

14. The electronic market according to claim 1, wherein said means for communicating comprises a web platform system in electronic communication with said auction transaction system and said catalog transaction system.

15. The electronic market according to claim 14, wherein said web platform system is adapted to provide an interactive web site for use by said buyers and said sellers, said interactive web site being securely accessible over the Internet.

16. The electronic market according to claim 15, wherein said interactive web site provides tracking and tracing in formation to each buyer of shipments that are scheduled to be delivered or in the process of being delivered by said sellers.

17. The electronic market according to claim 1, wherein said means for communicating comprises an electronic data interchange system in electronic communication with said auction transaction system and said catalog transaction system.

18. The electronic market according to claim 17, wherein said electronic data interchange system is adapted to enable electronic communication with private computer networks of said buyers and sellers.

19. The electronic market according to claim 18, wherein said electronic data interchange system uploads quoted rates for various transportation services from a private computer network of at least one seller.

20. The electronic market according to claim 18, wherein said electronic data interchange system downloads quoted rates to a private computer network of at least one seller.

21. The electronic market according to claim 18, further comprising an execution system in electronic communication with said auction transaction system and said catalog transaction system and wherein said electronic data interchange system sends tender offers and purchase orders generated by said execution system electronically to said sellers via said electronic data interchange system.

22. The electronic market according to claim 21, wherein said execution system interacts with billing systems and messaging systems of private networks of said buyers and said sellers through said electronic data interchange system.

23. A method for negotiating transactions regarding the exchange of transportation services between buyers and sellers that comprise a market place, said method comprising establishing an electronic exchange network that enables said buyers at their option to schedule desired services according to transaction catalogs published by said sellers, to place bids on transportation capacity being auctioned by sellers in seller's auctions, or to conduct a buyer's auction enabling sellers to place bids on the right to perform said desired services of said buyers.

24. The method according to claim 22, wherein said electronic exchange network enables auctions to be either non-public or public, wherein only buyers designated by an initiator of a non-public seller's auction as preferred trading partners can place bids on the particular transportation capacity being auctioned in said non-public seller's auction, and wherein only sellers designated by an initiator of a non-public buyer's auction as preferred trading partners can place bids on the particular right to perform said desired services that is being in said non-public buyer's auction.

25. The method according to claim 24, wherein said non-public auctions are converted into public auctions if no winning bids are received from said designated trading partners.

26. The method according to claim 24, wherein said non-public auctions contain multiple auction levels wherein different preferred trading partners are designated for each level.

27. The method according to claim 23, wherein winning bids in said auctions are determined manually by an auction initiator at any time during the auction.

28. The method according to claim 23, wherein if a winning bid for each seller's auction is identified said electronic exchange network automatically sends a tender offer to an initiator of said sellers auction.

29. The method according to claim 23, wherein said electronic exchange network enables each of said sellers to publish one or more preferred customer catalogs that are made accessible by said electronic exchange network only to buyers that are designated preferred catalog customers by a publishing seller.

30. The method according to claim 23, wherein said published transaction catalogs comprise a description of transportation services quoted as being made available by each seller to said buyers and associated fee rates for those services, and wherein said buyer can identify services and rates for said desired services by matching said quoted transaction services according to a manner selected from the group consisting of:
manually reviewing said published transaction catalogs for sellers of interest, and manually identifying matching services having acceptable rates for said desired services;
querying said electronic exchange network so as to cause said network to search among said published transaction catalogs of one or more sellers and automatically identify matching services, and reviewing said automatically matched queried services and identifying a desired one of said automatically matched queried services; and
identifying a desired seller and describing said desired services and commanding said electronic exchange network to identify matching services from said published transaction catalog of said desired seller and to automatically select a best one of said matched desired seller services.

31. The method according to claim 30, wherein said electronic exchange network automatically sends a purchase order for said matched desired seller services to said desired seller.

32. The method according to claim 30, wherein said electronic exchange network automatically sends a purchase order for said desired one of said automatically matched queried services to an appropriate seller.

33. The method according to claim 30, wherein said electronic exchange network automatically sends a purchase order for said manually identified matched service having acceptable rates for said desired services to an appropriate seller.

34. The method according to claim 30, wherein said electronic exchange network automatically identifies said desired one of said automatically matched queried services.

35. A method for conducting multiple level non-public auctions in a transportation services market among a plurality of buyers and a plurality of sellers, said method comprising:
establishing the format of the auction as having multiple levels of non-public auction;
defining auction parameters detailing form of acceptable bids and an identification of a transportation service being auctioned, said auction parameters including the designation of certain buyers or sellers as preferred trading partners for one or more levels of said multiple level non-public auction wherein only those buyers or sellers designated as preferred trading partners may bid in any one level of said multiple level non-public auction; and for each level of said multiple level non-public auction publishing notice to said buyers or said sellers designated as preferred trading partners;
receiving from said designated preferred trading partners and monitoring said received bids for a winning bid; and
proceeding to a next lower level of said non-public auction if an instruction is received to terminate a current level.

36. The method according to claim 35, wherein said instruction to terminate said current level of said multiple level non-public auction comprises a manual instruction by an auction initiator.

37. The method according to claim 35, wherein said instruction to terminate said current level of said multiple level non-public auction is automatically given after the expiration of a set period of time of receiving and monitoring bids for the current level within which said winning bid was not identified.

38. The method according to claim 35, wherein said winning bid must meet a pre-determined strike price.
